(19) United States
(12) Patent Application Publication
(10) Pub. No.: US 2020/0014149 A1
(43) Pub. Date: Jan. 9, 2020

(54) HIGH-SPEED CONNECTOR ASSEMBLY, SOCKET CONNECTOR AND SOCKET TERMINAL

(71) Applicant: OUPIIN ELECTRONIC (KUNSHAN) CO., LTD., Jiangsu province (CN)

(72) Inventor: HSIN CHIH CHEN, Jiangsu province (CN)

(21) Appl. No.: 16/411,426

(22) Filed: May 14, 2019

(30) Foreign Application Priority Data
Jul. 5, 2018 (CN) 201810732226.9

(51) Int. Cl. H01R 13/6461; H01R 12/57; H01R 12/72; H01R 13/66; H01R 12/73; H01R 13/11; H01R 13/24; H01R 13/514; H01R 13/6585

(52) U.S. Cl. CPC H01R 13/6461; H01R 12/57; H01R 12/724; H01R 13/6658; H01R 13/6585; H01R 13/11; H01R 13/2492; H01R 13/514; H01R 12/737

(57) ABSTRACT

A high-speed connector assembly, a socket connector and a socket terminal are disclosed in the present invention. The socket terminal includes a first branch, a second branch and a clamping port. The first branch and the second branch are independent, coplanar, unequal-height and unequal-length. The first branch has a first protrusion formed by stamping and protruding toward the clamping port; and the second branch has a second protrusion formed by stamping and protruding toward the clamping port. The first protrusion and the second protrusion can clamp two opposite surfaces of a plug terminal to form double contacts between the socket terminal and the plug terminal, thereby improving a signal throughput of the high-speed connector assembly, constructing a reliable mechanical connection between the socket terminal and the plug terminal, and ensuring an excellent electrical contact performance between the both.

### BACKGROUND OF THE INVENTION

### 1. Field of the Invention

The present invention relates to a connector technology, and more particularly to a high-speed connector assembly, a socket connector and a socket terminal, wherein the socket terminal forms a clamping port.

### 2. Description of the Prior Art

A backplane connector is widely used in communication technology. It is one common connector, which is used for large scale communication equipment, a super high performance server, a huge computer, an industrial computer and a high-end storage device. The backplane connectors are to connect daughter cards and backplanes. The daughter card and the backplane are vertical at 90 degrees.

With the continuous improvement of communication technology, the requirement for data transmission rate is also getting higher and higher. A high-speed backplane is a part of a typical electronic system that connects each module physically. A complex system relies on connection lines, routes and connectors of the backplane to process a large number of high-speed data streams. A high-speed backplane connector plays an important role in the communication between multiple backplane modules, so it is necessary to increase the technical research of the backplane connector to meet the signal rate requirements of high-speed communication systems.

The theme of this research is how to ensure the reliability and excellent electrical contact performance of mechanical connection between a high-speed backplane socket connector and a plug connector.

### BRIEF SUMMARY OF THE INVENTION

A first object of the present invention is to provide a high-speed connector assembly, which can construct a reliable mechanical connection and a stable signal transmission, can reduce crosstalk and loss, and can provide a greater signal throughput for high-speed signals.

A second object of the present invention is to provide a socket connector, which can construct a special electrical contact mode with a plug connector to ensure a reliable mechanical connection and a stable signal transmission, while reducing crosstalk and loss, so as to provide a greater signal throughput for high-speed signals.

A third object of the present invention is to provide a socket terminal, which can form a reliable mechanical connection and ensure an excellent electrical contact performance between the socket terminal and a corresponding plug terminal, so as to provide a greater signal throughput for high-speed signals.

Other objects and advantages of the present invention may be further understood from the technical features disclosed by the present invention.

To achieve the aforementioned object or other objects of the present invention, the present invention adopts the following technical solution.

The present invention provides a high-speed connector assembly, comprising a plug connector and a socket connector. The plug connector includes multiple plug terminals, each of which is straight, and has a mating end and a tail end. The mating end has a rectangular cross section and has two parallel narrow surfaces. The socket connector includes an insulating cover and multiple terminal modules arranged side by side and retained in the insulating cover. Each terminal module includes at least an insulating frame and a socket terminal group retained in the insulating frame. The socket terminal group includes multiple pairs of differential signal socket terminals and multiple grounding terminals. The differential signal socket terminals are located in a vertical plane. Each of the differential signal socket terminals has an L-type body located in the vertical plane, a front mating portion extending forward from one end of the body and being located in the vertical plane, and a bottom mounting portion extending downward from the other end of the body and being located in the vertical plane. The front mating portion includes a first branch, a second branch and a clamping port defined by the first branch and the second branch. The first branch and the second branch are independent, coplanar, unequal-height and unequal-length. The first branch has a first protrusion, which is formed by stamping, protrudes toward the clamping port and is perpendicular to one narrow surface of the corresponding plug terminal. The second branch has a second protrusion, which is formed by stamping, protrudes toward the clamping port and is perpendicular to the other narrow surface of the plug terminal. A length of the second branch is greater than that of the first branch, and the second protrusion is located in front of the first protrusion. When the socket connector and the plug connector are mating, the second protrusion first contacts with the other narrow surface and slides along the other narrow surface toward the tail end; then the first protrusion contacts one narrow surface and slides along one narrow surface toward the tail end, and finally the mating end of the plug terminal arrives at a predetermined position of the clamping port.

In one embodiment, the first branch and the second branch are parallel and are located in the vertical plane.

In one embodiment, each pair of differential signal socket terminals includes two differential signal socket terminals; one grounding terminal is arranged above and below each pair of differential signal socket terminals; and a width of each grounding terminal is greater than that of each differential signal socket terminal.

The present invention provides a socket connector, which comprises an insulating cover and multiple terminal modules being arranged side by side and retained in the insulating cover. Each terminal module at least includes an insulating frame and a socket terminal group located in the insulating frame. The socket terminal group includes multiple pairs of differential signal socket terminals and multiple grounding terminals. The differential signal socket terminals are located in a vertical plane. Each of the differential signal socket terminals has an L-type body located in the vertical plane, a front mating portion extending forward from one end of the body and located in the vertical plane, and a bottom mounting portion extending downward from the other end of the body and located in the vertical plane. The front mating portion includes a first branch in the vertical plane, a second branch in the vertical plane and a clamping port defined by the first branch and the second branch. The first branch and the second branch are independent, unequal-height and unequal-length. The first branch has a first protrusion, which is formed by stamping and protrudes toward the clamping port. The second branch has a second protrusion, which is formed by stamping and protrudes toward the clamping port. When the socket connector is engaged with a plug connector, one plug terminal of the plug connector can be inserted into the clamping port, and the first and second protrusions can electrically contact with two parallel narrow surfaces of the plug terminal, respectively.

In one embodiment, the first branch and the second branch are parallel.

In one embodiment, a length of the second branch is greater than that of the first branch, and the second protrusion is located in front of the first protrusion.

The present invention provides a socket terminal, which comprising an L-type body being located in a vertical plane, a front mating portion extending forward from one end of the body and being located in the vertical plane, and a bottom mounting portion extending downward from the other end of the body and being located in the vertical plane. The front mating portion includes a first branch in the vertical plane, a second branch in the vertical plane and a clamping port defined by the first branch and the second branch. The first branch and the second branch are independent, unequal-height and unequal-length. The first branch has a first protrusion, which is formed by stamping, is located in the vertical plane, protrudes toward the clamping port and is used to electrically contact with one narrow surface of one plug terminal. The second branch has a second protrusion, which is formed by stamping, is located in the vertical plane, protrudes toward the clamping port and is used to electrically contact with the other narrow surface of the plug terminal. The clamping port is used for inserting the plug terminal. The first and second protrusions are capable of holding the plug terminal.

In comparison with the prior art, the socket terminal of the present invention disposes two independent, unequal-height, unequal-length and coplanar branches to form double contacts with two opposite surfaces of the corresponding plug terminal, thereby improving the signal throughput of the high-speed connector assembly, constructing a reliable mechanical connection between the socket terminal and the plug terminal, and having an excellent electrical contact performance between the both. Meanwhile, when the transmission rate of the high speed signal is greater than 25 Gbps-40 Gbps, the high-speed connector assembly of the present invention can restrain a short pile effect, reduce crosstalk and loss and ensure more stable and reliable signal transmission quality.

### BRIEF DESCRIPTION OF THE DRAWINGS

FIG. 1 is a perspective view of a high-speed connector assembly of the present invention;

FIG. 2 is a disassembled view of the high-speed connector assembly of the present invention;

FIG. 3 is a disassembled view of the high-speed connector assembly along another direction;

FIG. 4 is a perspective view of one socket terminal group of a socket connector of the present invention;

FIG. 5 is a plan view of the socket terminal group shown in FIG. 4;

FIG. 6 is a perspective view of one pair of differential signal socket terminals in the socket terminal group shown in FIG. 4;

FIG. 7 is a simulation view showing that the pair of differential signal socket terminals of FIG. 6 electrically contact with one pair of plug terminals; and

FIG. 8 is a simulation plan view showing that the pair of differential signal socket terminals of FIG. 6 electrically contact with the pair of plug terminals.

### DETAILED DESCRIPTION OF THE PREFERRED EMBODIMENTS

The following description of every embodiment with reference to the accompanying drawings is used to exemplify a specific embodiment, which may be carried out in the present invention. Directional terms mentioned in the present invention, such as “up”, “down”, “front”, “back”, “left”, “right”, “top”, “bottom” “above”, “below” etc., are only used with reference to the orientation of the accompanying drawings. Therefore, the used directional terms are intended to illustrate, but not to limit, the present invention.

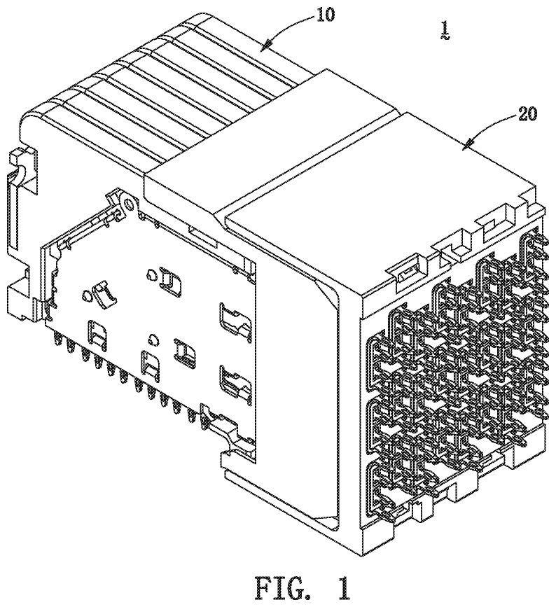

Please refer to FIGS. 1 to 3, a high-speed connector assembly 1 of the present invention includes a socket connector 10 and a plug connector 20. The socket connector 10 may be a right-angle connector, the mating direction of which is parallel to a horizontal circuit board (not shown), on which the socket connector 10 is mounted. The plug connector 20 may be a vertical end connector, the mating direction of which is perpendicular to a vertical circuit board (not shown), on which the plug connector 20 is mounted.

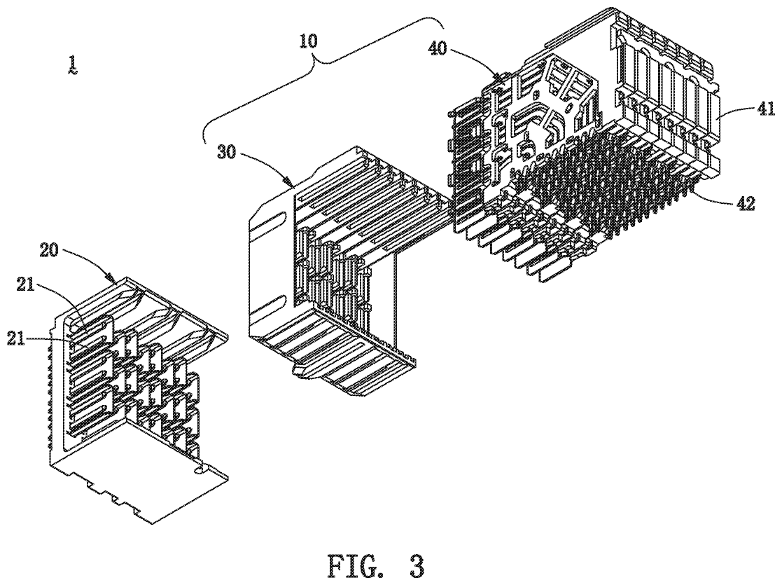

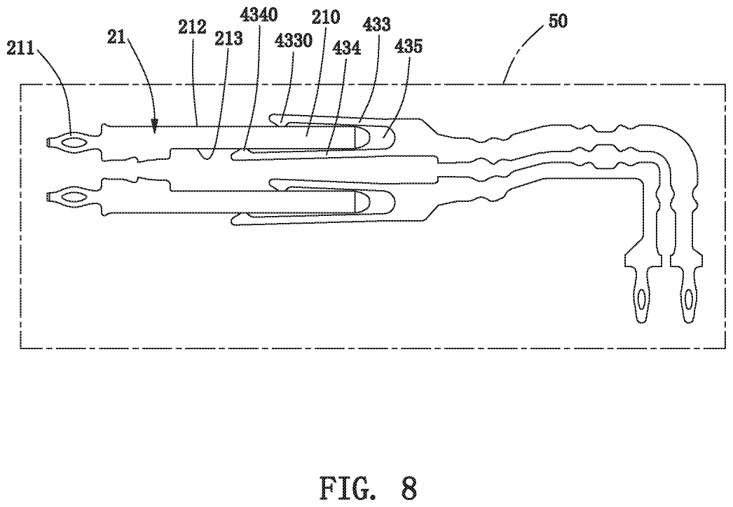

Referring to FIG. 3, the plug connector 20 has multiple differential signal plug terminals 21. Referring to FIG. 8, each plug terminal 21 is straight, and has a mating end 210 and a tail end 211. The mating end 210 has a rectangular cross section, and has two parallel narrow surfaces 212, 213. The two narrow surfaces 212, 213 are actually side edges of the mating end 210, or called cut edges.

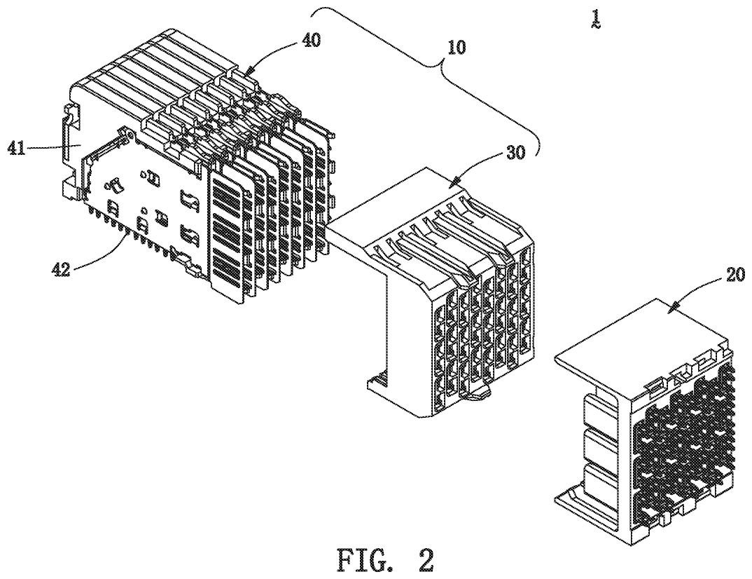

Referring to FIGS. 2 and 3, the socket connector 10 includes an insulating cover 30 and multiple terminal modules 40 mounted in the insulating cover 30 and arranged side by side from left to right.

Referring to FIGS. 2 and 3, each terminal module 40 includes at least an insulating frame 41, and a socket terminal group 42 retained in the insulating frame 41.

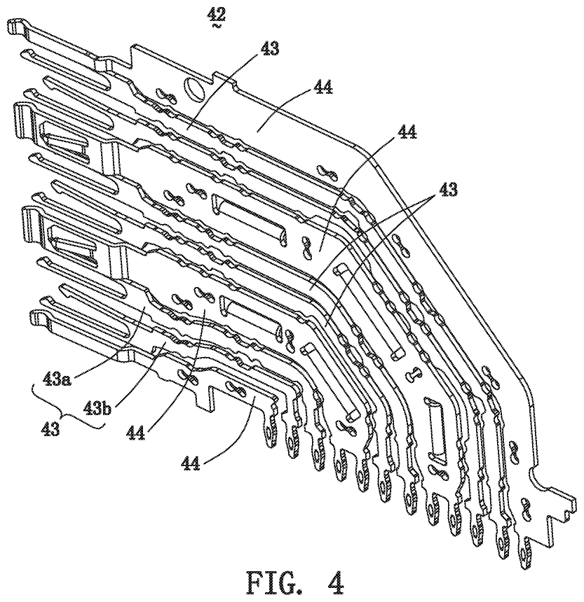

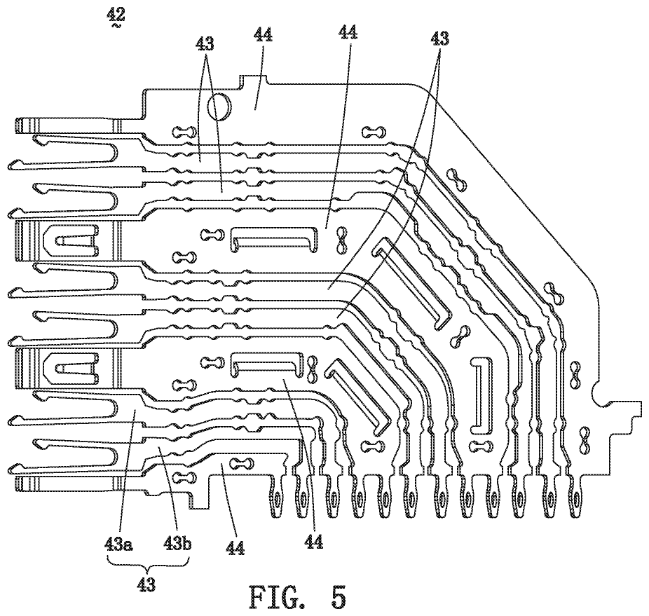

Referring to FIGS. 4 and 5, the socket terminal group 42 includes multiple pairs of differential signal socket terminals 43 and multiple grounding terminals 44. There is one grounding terminal 44 arranged above and below each pair of differential signal socket terminals 43. In the embodiment, each pair of differential signal socket terminals 43 includes two differential signal socket terminals 43a, 43b, and the width of each grounding terminal 44 is greater than that of each differential signal socket terminal 43.

The structure of the socket terminal will be described in detail with one pair of differential signal socket terminals 43 as an example.

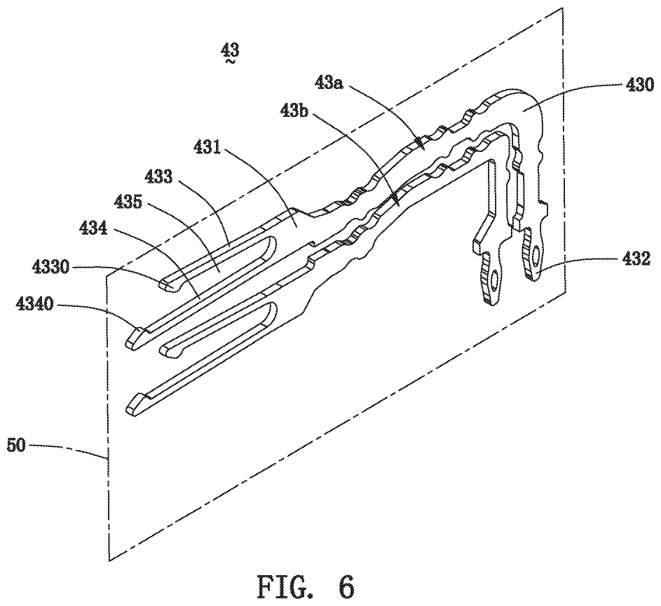

Referring to FIG. 6, the pair of differential signal socket terminals 43 is located in a vertical plane 50. Each differential signal socket terminal 43a (43b) has an L-type body 430 located in the vertical plane 50, a front mating portion 431 extending forward from one end of the body 430 and located in the vertical plane 50, and a bottom mounting portion 432 extending downward from the other end of the body 430 and located in the vertical plane 50.

Referring to FIG. 6, the front mating portion 431 includes a first branch 433, a second branch 434 coplanar with the first branch 433, and a clamping port 435 defined by the first branch 433 and the second branch 434. The first branch 433 and the second branch 434 are independent, unequal in height and length. Specifically, the first branch 433 is located in the vertical plane 50 and extends horizontally and straight forward. The first branch 433 has a first protrusion 4330 formed by stamping on a side edge of a front end thereof. The first protrusion 4330 is engaged with one narrow surface 212 of the plug terminal 21. The second branch 433 is located in the vertical plane 50 and extends horizontally and straight forward. The second branch 434 has a second protrusion 4340 formed by stamping on a side edge of a front end thereof. The second protrusion 4340 is engaged with the other narrow surface 213 of the plug terminal 21.

Referring to FIG. 6, in the embodiment, the first branch 433 and the second branch 434 are arranged in parallel. The first protrusion 4330 and the second protrusion 4340 are protruding toward the clamping port 435. Moreover, it should be noted that, when the mating end 210 of the plug terminal 21 is inserted into the socket terminal 43, the first branch 433 and the second branch 434 will be forced to open outward, while the clamping port 435 will be slightly expanded, so as to provide an enough clamping force for the plug terminal 21.

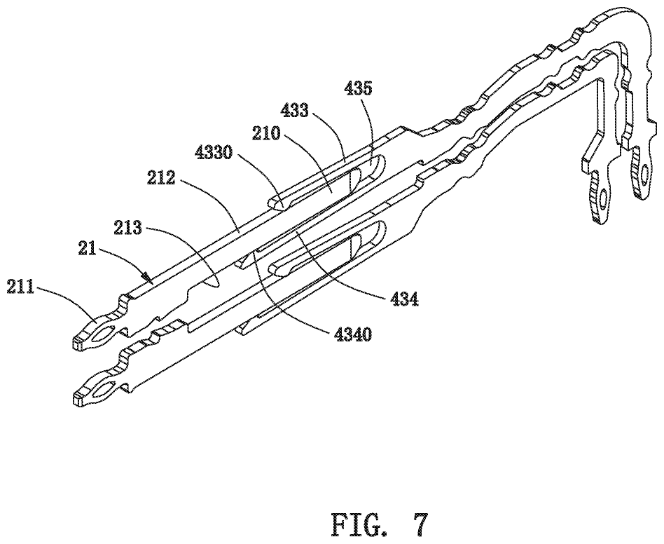

More specifically, referring to FIG. 7, the first protrusion 4330 is perpendicular to one narrow surface 212 of the plug terminal 21, and the second protrusion 4340 is perpendicular to the other narrow surface 213 of the plug terminal 21.

Referring to FIGS. 7 and 8, the first protrusion 4330 and the second protrusion 4340 are located in the vertical plane 50 (seen in FIG. 8), and are protruding toward the narrow surfaces 231, 213 of the plug terminal 21, respectively. When the two connectors are engaged, the first protrusion 4330 can form an electrical contact with one narrow surface 212 of the plug terminal 21, and the second protrusion 4340 can form an electrical contact with the other narrow surface 213 of the plug terminal 21.

In the embodiment, the first protrusion 4330 and the second protrusion 4340 are formed by punching, blanking or cutting, which can be realized by the same stamping die.

Moreover, referring to FIGS. 7 and 8, a length of the second branch 434 is greater than that of the first branch 433, and the second protrusion 4340 is located in front of the first protrusion 4330, so the second protrusion 4340 is closer to the tail end 211 of the plug terminal 21 than the first protrusion 4330. When mating, the second protrusion 4340 can first contact with the narrow surface 213 of the plug terminal 21, and then the first protrusion 4330 can contact the narrow surface 212 of the plug terminal 21. The plug terminal 21 will not stop inserting until the mating end 210 of the plug terminal 21 arrives at a predetermined position of the clamping port 435. By this design of double contacts, the high-speed connector assembly 1 has a greater signal throughput for high-speed signals, and there forms a reliable mechanical connection and has an excellent electrical contact performance between the socket terminals (namely the two differential signal socket terminals 43a, 43b) and the plug terminals 21. Further, the design of the clamping port 435 can improve the clamping force of the socket terminal to the plug terminal 21.

When the socket connector 10 and the plug connector 20 are electrically mating, referring to FIG. 8, the first protrusion 4330 of the first branch 433 slides along one narrow surface 212 of the mating end 210 toward the tail end 211 and finally rests on the narrow surface 212; and the second protrusion 4340 of the second branch 434 slides along the other narrow surface 213 of the mating end 210 toward the tail end 211 and finally rests on the narrow surface 213. At last, the mating end 210 of the plug terminal 21 arrives at the predetermined position of the clamping port 435. In this connection way, the pair of differential signal socket terminals 43 of the socket connector 10 and one pair of corresponding plug terminals 21 of the plug connector 20 can form a reliable mechanical connection and have an excellent electrical contact performance therebetween.

As described above, in the present invention, the socket terminal (i.e. a single differential signal socket terminal 43) disposes two independent, unequal-height, unequal-length and coplanar branches 433, 434 to form the double contacts with two opposite surfaces (i.e. the narrow surfaces 212, 213) of the corresponding plug terminal 21, thereby improving the signal throughput of the high-speed connector assembly 1, constructing the reliable mechanical connection between the socket terminal and the plug terminal 21, and having the excellent electrical contact performance between the both. Meanwhile, when the transmission rate of the high speed signal is greater than 25 Gbps-40 Gbps, the high-speed connector assembly 1 of the present invention can restrain a short pile effect, reduce crosstalk and loss and ensure more stable and reliable signal transmission quality.

What is claimed is:

1. A high-speed connector assembly, comprising:
a plug connector, including multiple plug terminals, each of which is straight and has a mating end and a tail end; a cross section of the mating end being rectangular and the mating end having two parallel narrow surfaces; and
a socket connector, including an insulating cover and multiple terminal modules arranged side by side and retained in the insulating cover; each terminal module including at least an insulating frame and a socket terminal group retained in the insulating frame; the socket terminal group including multiple pairs of differential signal socket terminals and multiple grounding terminals;
wherein the differential signal socket terminals are located in a vertical plane, each of the differential signal socket terminals having an L-type body located in the vertical plane, a front mating portion extending forward from one end of the body and being located in the vertical plane, and a bottom mounting portion extending downward from the other end of the body and being located in the vertical plane;
wherein the front mating portion includes a first branch, a second branch and a clamping port defined by the first branch and the second branch; the first branch and the second branch being independent, coplanar, unequal-height and unequal-length; the first branch having a first protrusion, which is formed by stamping, protrudes toward the clamping port and is perpendicular to one narrow surface of the corresponding plug terminal; the second branch having a second protrusion, which is formed by stamping, protrudes toward the clamping port and is perpendicular to the other narrow surface of the plug terminal; a length of the second branch being greater than that of the first branch, and the second protrusion being located in front of the first protrusion;
when the socket connector and the plug connector are mating, the second protrusion first contacts with the other narrow surface and slides along the other narrow surface toward the tail end, then the first protrusion contacts one narrow surface and slides along one narrow surface toward the tail end, and finally the mating end of the plug terminal arrives at a predetermined position of the clamping port.

2. The high-speed connector assembly as claimed in claim 1, wherein the first branch and the second branch are parallel and are located in the vertical plane.

3. The high-speed connector assembly as claimed in claim 1, wherein each pair of differential signal socket terminals includes two differential signal socket terminals; one grounding terminal is arranged above and below each pair of differential signal socket terminals; and a width of each grounding terminal is greater than that of each differential signal socket terminal.

4. A socket connector, comprising:
an insulating cover; and
multiple terminal modules, being arranged side by side and retained in the insulating cover; each terminal module at least including an insulating frame and a socket terminal group located in the insulating frame; the socket terminal group including multiple pairs of differential signal socket terminals and multiple grounding terminals; wherein the differential signal socket terminals are located in a vertical plane, each of the differential signal socket terminals having an L-type body located in the vertical plane, a front mating portion extending forward from one end of the body and located in the vertical plane, and a bottom mounting portion extending downward from the other end of the body and located in the vertical plane;
wherein the front mating portion includes a first branch in the vertical plane, a second branch in the vertical plane and a clamping port defined by the first branch and the second branch; the first branch and the second branch being independent, unequal-height and unequal-length; the first branch having a first protrusion, which is formed by stamping and protrudes toward the clamping port; the second branch having a second protrusion, which is formed by stamping and protrudes toward the clamping port;
when the socket connector is engaged with a plug connector, one plug terminal of the plug connector can be inserted into the clamping port, and the first and second protrusions can electrically contact with two parallel narrow surfaces of the plug terminal, respectively.

5. The socket connector as claimed in claim 4, wherein the first branch and the second branch are parallel.

6. The socket connector as claimed in claim 4, wherein a length of the second branch is greater than that of the first branch, and the second protrusion is located in front of the first protrusion.

7. The socket connector as claimed in claim 4, wherein each pair of differential signal socket terminals includes two differential signal socket terminals; one grounding terminal is arranged above and below each pair of differential signal socket terminals; and a width of each grounding terminal is greater than that of each differential signal socket terminal.

8. A socket terminal, comprising:
an L-type body, being located in a vertical plane;
a front mating portion, extending forward from one end of the body and being located in the vertical plane; and
a bottom mounting portion, extending downward from the other end of the body and being located in the vertical plane;
wherein the front mating portion includes a first branch in the vertical plane, a second branch in the vertical plane and a clamping port defined by the first branch and the second branch; the first branch and the second branch being independent, unequal-height and unequal-length; the first branch having a first protrusion, which is formed by stamping, is located in the vertical plane, protrudes toward the clamping port and is used to electrically contact with one narrow surface of one plug terminal; the second branch having a second protrusion, which is formed by stamping, is located in the vertical plane, protrudes toward the clamping port and is used to electrically contact with the other narrow surface of the plug terminal; the clamping port being used for inserting the plug terminal; and the first and second protrusions being capable of holding the plug terminal.

9. The socket terminal as claimed in claim 8, wherein the first branch and the second branch are parallel.

10. The socket terminal as claimed in claim 8, wherein a length of the second branch is greater than that of the first branch, and the second protrusion is located in front of the first protrusion.
